(19) United States
(12) Patent Application Publication
(10) Pub. No.: US 2005/0204013 A1
(43) Pub. Date: Sep. 15, 2005

(54) Portable personal computing environment technologies

(75) Inventors: Mandayam Thondanur Raghunath, Fishkill, NY (US); Chandrasekhar Narayanaswami, Wilton, CT (US); Ramon Caceres, New York, NY (US); Stefan Berger, New York, NY (US)

Correspondence Address: MICHAEL J. BUCHENHORNER, ESQ;HOLLAND & KNIGHT, 701 BRICKELL AVENUE, MIAMI, FL, 33131, US

(73) Assignee: International Business Machines Corporation

(21) Appl. No.: 10/795,153

(22) Filed: Mar. 5, 2004

(51) Int. Cl. G06F 15/16

(52) U.S. Cl. 709/217; 709/205; 709/246; 709/219

(57) ABSTRACT

A portable personal computing environment server comprises an interface for connecting to a host computer. The portable personal computing environment server also comprises a mass storage device storing a personal computing environment including one or more guest operating systems for restoring the personal computing environment in the host system.

### CROSS-REFERENCE TO RELATED APPLICATIONS

Not Applicable.

### STATEMENT REGARDING FEDERALLY SPONSORED-RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of information processing systems and more particularly relates to the field of portable personal computing devices.

### BACKGROUND OF THE INVENTION

As computers have become among the most important tools in the current business environment, many users rely on multiple computing devices to perform varied tasks. Some of the current problems that chief information officers and users face include: 1) multiplication of the costs of managing machines (virus protection, security patches, application upgrades); 2) cost of multiple operating system and application licenses; 3) creating disk backups; 4) maintaining machine and disk passwords; 5) difficulty of restoring machines after disk crashes; 6) securing against network attacks; and 7) user data being scattered across a collection of machines. There have been several attempts to address these concerns. Users are primarily concerned with access to information relating to the tasks that they were performing using their computers. Since some of these tasks are long running, users desire the ability to suspend partially completed tasks and resume working on these tasks at a later point in time. For instance, a user may start editing a document at the office, and would like to continue working on the document at home, or the next day at a different location. Currently laptop computers help address this requirement. Users routinely suspend their laptops and resume them later. The suspend-resume cycle preserves the computation state on the user's laptop, enabling users to quickly suspend their tasks and resume them later.

However, laptop computers come with a set of disadvantages. Laptop computers are relatively large and heavy because they contain everything: CPU, memory, disk storage, as well as the screen, keyboard and pointing device. Laptops also do not operate for a very long duration of time when powered solely by internal batteries.

Given the widespread availability of computers and peripherals such as keyboards, pointing devices, monitors, and the like, it may not be necessary for a user to carry all of these items in the form of a laptop computer.

It would be advantageous to devise a scheme where a user can take advantage of a widely-deployed installed base of personal computers, to suspend and resume their tasks at different locations while carrying something that is much smaller, lighter and less onerous to maintain than a laptop computer.

The key to suspending and resuming tasks is to find a way by which a user's personal computing environment can be moved from one location to another. A user's personal computing environment consists of the instantaneous state of the applications the user is working on, the configuration of the applications, the operating system on which the applications run and the configuration of the operating system. It is all the more important to be able to move a user's personal computing environment from one place to another in a manner that takes advantage of the widely deployed personal computing infrastructure, in a manner that uses existing systems without trying to force them to change or attempting to replace them with other systems.

We first consider existing approaches that attempt to transport a user's personal computing environment along with the user.

The IBM Meta Pad is a portable device comprising a CPU, memory, disk, a suspend battery, and a docking connector which connects to a docking station which in turn connects to a mouse, keyboard and screen. Users work on their tasks using the Meta Pad and suspend it like they would suspend a laptop and eject the Meta Pad from its dock. The suspend battery maintains the state in the Meta Pad. The Meta Pad eliminates the need to carry the screen, keyboard and the pointing device. An inconvenience of this approach is that a proprietary Meta Pad docking station is needed at each location where the user needs access and it effectively attempts to dislodge the existing installed base of personal computers.

The Intel Personal server is a device comprising a CPU, memory, disk and Bluetooth or IEEE 802.11 network interface. Such a device can communicate with a standard personal computer, but the main problem with this approach is the use of wireless connections for exchanging all data between the personal computer and Intel Personal Server. Every communication requires HTTP server/SOAP connections from an environment to a belt worn server. While this concept has some merit, it requires the environmental personal computer to support standard interfaces as well as applications to deal with the data that is carried on the personal server. The environmental personal computers still need to be administered and managed, and the battery life of the personal server is a serious usability problem. The Intel Personal Server does not enable the user to carry their personal computing environment with them. It only enables them to access some information that is on their Personal Server device at different locations.

Currently Linux operating system distributions exist that contain an entire operating system and applications on a bootable CD/DVD (compact disk/digital video disk) or other read-only media. Users can boot any PC (personal computer) from the CD and create a familiar desktop environment on it. Further they may carry read/write USB (Universal Serial Bus) flash storage with their personal files. In this approach the user's computation state is not preserved as the user moves from one machine to another. Further, the user needs to carry two items, the bootable read-only CD and a R/W storage device for data that is modifiable.

The diskless Sun Java Station/IBM Network computer attempted to solve some of the above problems by using a thin client connected to a fat server by fat pipes. This approach has the drawback that it relies heavily on a browser, the Java OS and Java applications. Slow connectivity, especially from remote locations, remained an issue with such an approach. The approach also took away the personalization aspect by disallowing the user to install any applications. In addition, this approach tried to dislodge and replace the existing personal computer ecosystem.

Internet Suspend/Resume (ISR) from Intel is a technology for transporting personal computing environments over a network. It relies on suspending and resuming the state of a virtual machine; it stores the suspended state on a distributed file system, from where it can later be retrieved and resumed. An important limitation of the ISR approach is that it requires network connectivity. It would be advantageous to do away with the need for any network connectivity by exploiting portable storage devices. Another limitation of ISR is that it requires that end systems be pre-configured with ISR software. It would be advantageous to have a system that does not require any software to be pre-installed on end systems because it carries a bootable image in the portable storage device.

The Microsoft Remote Desktop provides a solution that just sends the key strokes and events to the host (server) computer. The host computer then sends the graphics over to the remote (client) computer. This is similar to what X11 did for workstations in the 80s and 90s. The session is not resumed where it was left off. This is just a client server approach.

Xmove is another approach (see Ethan Solomita, James Kempf, and Dan Duchamp, “XMove: A Pseudoserver for X Window Movement,” The X Resource, (1):11, pp. 143-170, July 1994) This allows an X window on the remote machine to be moved to another remote machine. The application continues to run on the same server machine. This is done by capturing the state for that particular X Window by introducing a pseudo server in the middle.

There have been a few implementations of window movement using the toolkit approach. Trestle is a toolkit that can move shell windows from one display to another. XTk is a window toolkit that allows window widgets to move from one server to another. XTk introduces an additional step in widget creation: screen binding. Screen binding binds a widget to a screen without geometrical layout. This allows the widget's geometry negotiation to account for screen geometry should it be moved. An additional step is also introduced in widget shutdown, to maintain widget structures in case they should be moved to another screen.

In the virtual network computing (VNC) system, server machines supply not only applications and data but also an entire desktop environment that can be accessed from any Internet-connected machine using a simple software NC. Whenever and wherever a VNC desktop is accessed, its state and configuration (right down to the position of the cursor) are exactly the same as when it was last accessed. The technology underlying VNC is a simple remote display protocol. Unlike other remote display protocols such as the X Window System and Citrix's ICA, the VNC protocol is totally independent of operating system, windowing system, and applications The VNC system is freely available for download from the ORL Web site at http://www.orl.co.uk/vnc/. It does not require the user to carry any hardware. However, it assumes network connectivity. See T. Richardson, Q. Stafford-Fraser, K. R. Wood, and A. Hopper, “Virtual Network Computing”, IEEE Internet Computing, Vol. 2 No.1, January/February 1998 pp 33-38.

Although the foregoing solutions all have their own merits, there is a need for a truly portable solution that can provide a user with his or her work environment in any host environmental computer regardless of its configuration or location.

### SUMMARY OF THE INVENTION

The above problems or shortcomings in portable computing environments are solved by using a portable personal computing environment server according to the invention. The portable personal computing environment server can be used in most host computer systems (e.g., PC-compatibles) regardless of their configurations. The portable personal computing environment server comprises the user's most recent computing state for restoration in the host system.

### BRIEF DESCRIPTION OF THE DRAWINGS

FIG. 1 is a high level block diagram showing an embodiment of a personal computing environment server.

FIG. 2 is a block diagram showing another embodiment of a personal computing environment server.

FIG. 3 is a block diagram showing an information processing system according to the first embodiment.

FIG. 4 is a block diagram showing an information processing system according to the second embodiment.

FIG. 5 is a block diagram illustrating the content of the storage device of the personal computing environment server.

FIG. 6 is a block diagram showing the runtime software layering on two different hosts.

FIG. 7 is a block diagram showing a suspend operation.

FIGS. 8A, 8B, and 8C are block diagrams showing a resume operation.

FIG. 9 is a flowchart of a start-up and boot method according to an embodiment of the invention.

FIG. 10 is a flowchart of a suspend method according to another embodiment of the invention.

### DETAILED DESCRIPTION

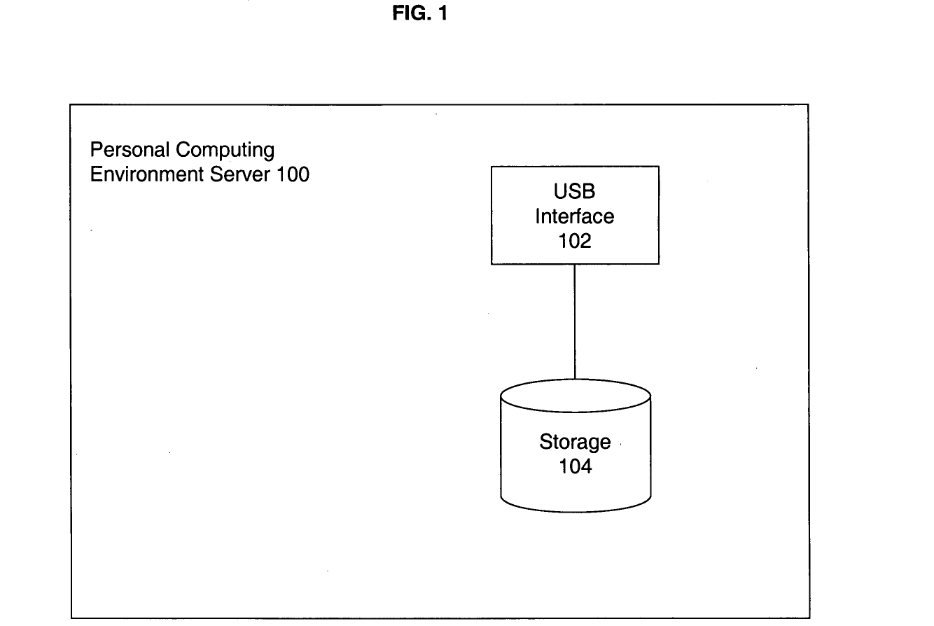

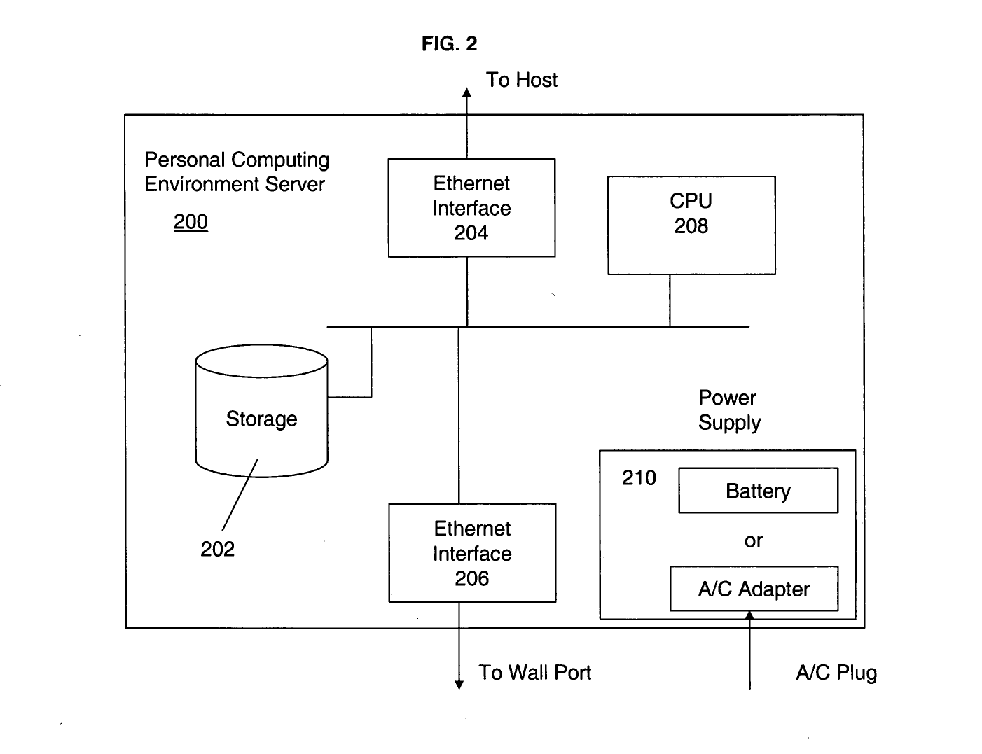

We solve the problems discussed above with an attachable storage device 100 (hereafter called a portable personal computing environment server or portable server) that can be connected to any host personal computer. Referring to FIG. 1, there is shown a portable server 100 according to an embodiment of the invention. The portable server comprises a mass storage device 102 and a USB (universal serial bus) port 104 for coupling to a host system. The storage device 102 with information and software that converts the host personal computer in the environment into a personalized computer, i.e., one that has software and data selected by the guest user and which resumes its computing state from the point it was last suspended. The portable personal computing environment server 100 is preferably a guest system that comprises suitable software to suspend and resume state, and to boot personal computers from a wired connection interface such as a USB (universal serial bus) or Ethernet interface 204 (discussed with respect to FIG. 2). The attached portable personal computing environment server 100 has a small form factor such as the size of a deck of cards but is expected to become even smaller as technology advances. The portable personal computing environment server 100 works with the already deployed and pervasive collection of personal computers, attaching to them over a fast local connection. Effectively, everything from the standard host personal computer, such as its central processor unit, memory, display, network, except its hard disk drive will be exploited. To be successful, the connection process should be quick and the portable device should be less onerous to maintain than a separate computer system or systems. The ideal solution should be very easy to use and should be able to resume computation at the same state where it was suspended.

Referring to FIG. 2, there is shown a portable server 200 according to another embodiment of the invention. In this embodiment the portable server 200 comprises a storage device 202 such as a hard disk drive or other suitable storage media and Ethernet interfaces/ports 204 and 206. Ethernet interface 204 connects to the host system and Ethernet interface 206 connects the portable server 200 to a local or wide area network, preferably through a wall port. The portable server 200 also comprises a central processor unit 208 and a power supply 210 using either a battery 212 or alternating current connection 214.

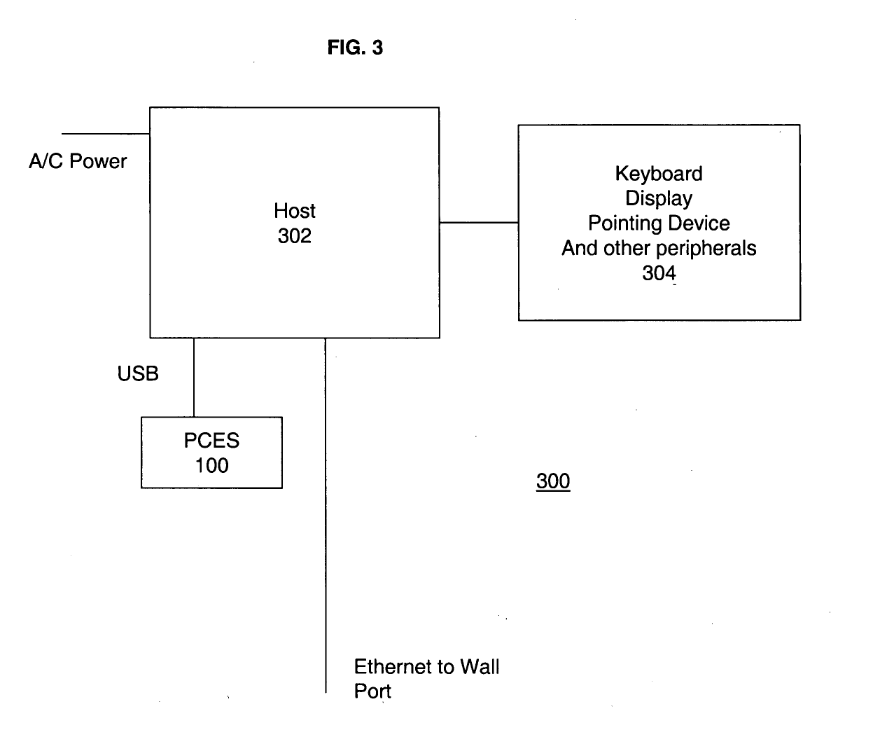

Referring to FIG. 3, there is shown the portable server 100 coupled with a host system 302. The host system 302 also comprises an I/O subsystem 304 that drives a standard set of peripheral devices such as a keyboards, mouse, and display. The host system 302 comprises a USB port coupled to the portable server 100 and an Ethernet port coupled to an Ethernet local or wide area network through the wall port.

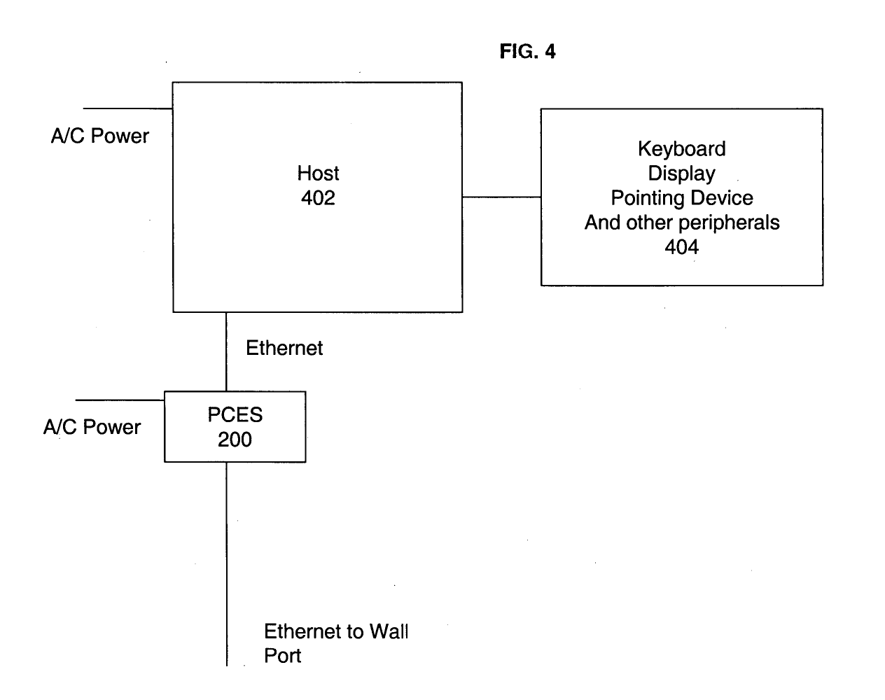

Referring to FIG. 4, there is shown the portable server 200 coupled with a host system 402. The host system 402 is connected to an I/O subsystem 404 that drives a standard set of peripheral devices such as a keyboards, mouse, and display. The host system 402 comprises a USB port coupled to the portable server and an Ethernet port coupled to an Ethernet local area network.

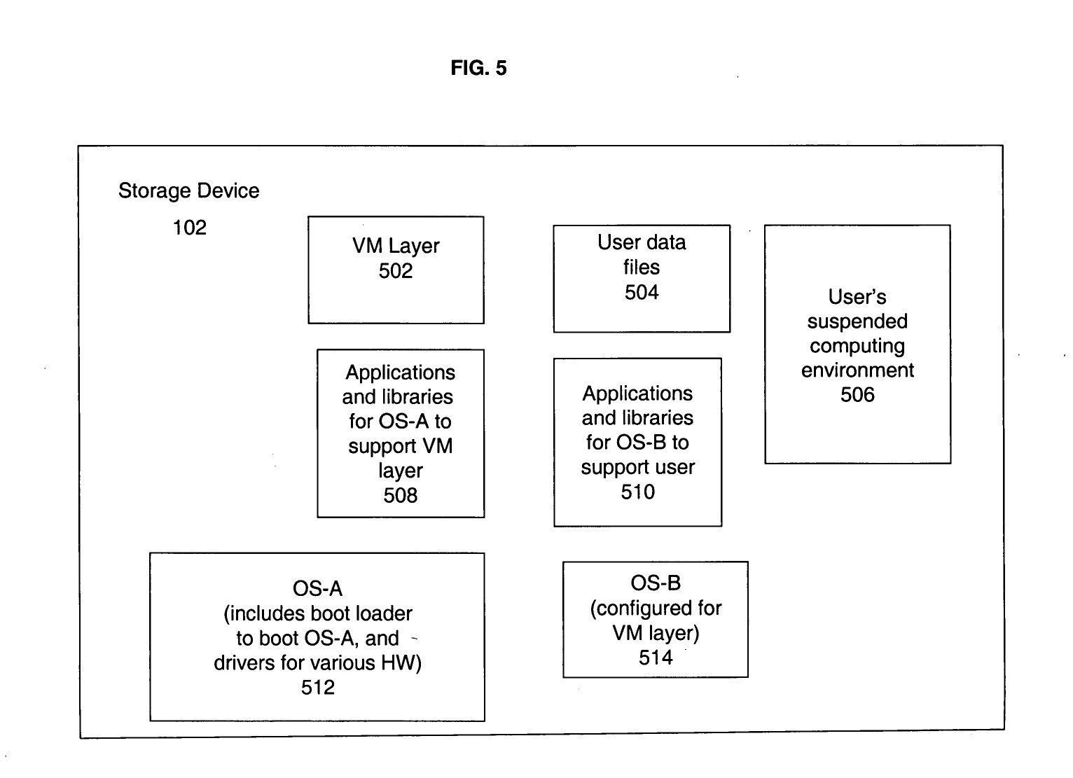

Referring to FIG. 5, there is shown the mass storage device 102 of the portable server 100 which stores all of the information and software required to restore the user's computing state as it existed when a prior session on a different host computer was suspended. The mass storage device 102 (see FIG. 1) comprises a first-level guest operating system OS-A 512, a second-level guest operating system OS-B 514, and a virtual machine layer 502. OS-A 512 includes a boot loader to boot OS-A and drivers for various hardware devices. OS-B 514 is configured for the virtual machine layer 502. The storage device also stores user data files 504, the user's suspended computing environment 506, applications and libraries 508 for OS-A 512 to support the VM layer 502 and applications and libraries 510 for OS-B 514 to support the user. The storage device must have sufficient storage capacity to store the operating systems and the user's computing environment and state.

Storage of all of the above software and data will require ten or more gigabytes of storage depending on how much of the computing environment and state the user wishes to capture in the storage device. The storage device 104 is preferably non-volatile so that a battery is not required. Even in embodiment 200, the storage device 202 is preferably non-volatile so that the battery or other power supply is not required when the personal computing environment server is not actively being used. Storage device 104 or 202 could be a hard disk drive, non-volatile semiconductor storage such as FLASH memory, a magnetic random access memory, optical storage or other suitable device.

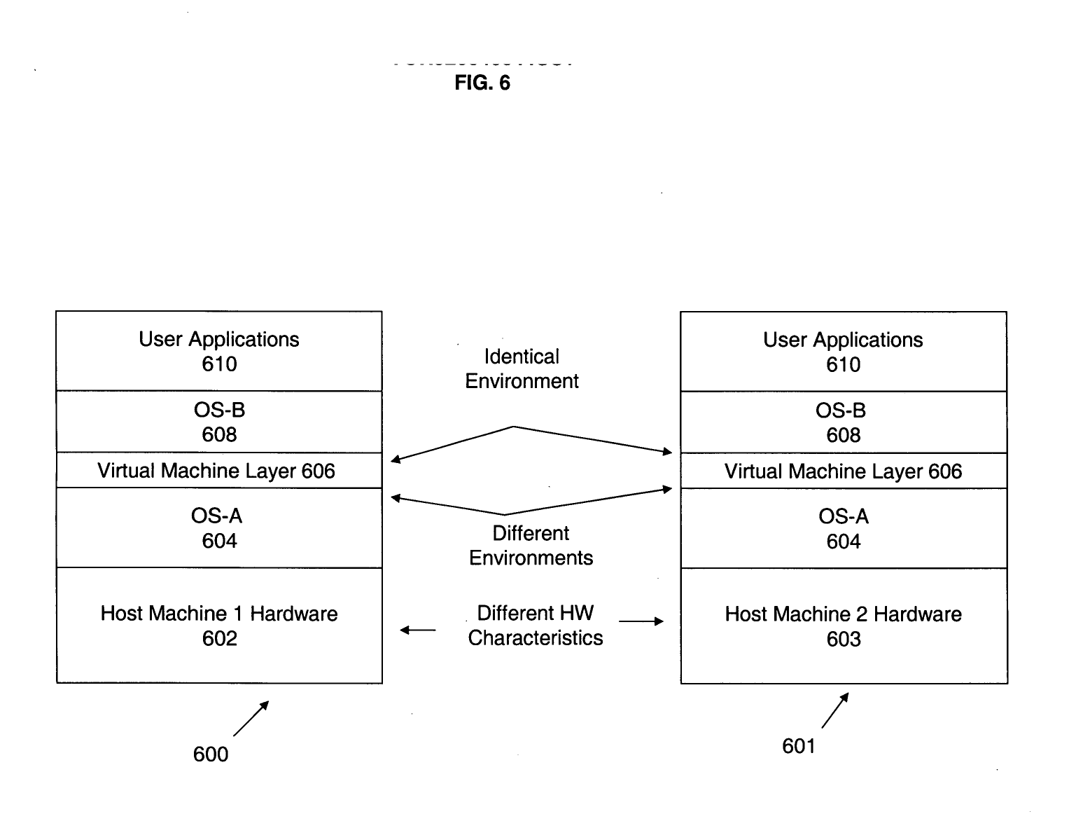

Referring to FIG. 6 there is shown a block diagram illustrating the runtime software layering on two different hosts. The layering is done so that the user applications 610 interact with the same OS-B layer 608. The software layering model 600 corresponds to a first host machine and the software layering model 601 corresponds to a second host machine. The first and second host machines have different hardware characteristics 602 and 603, respectively. Each layering model has an OS-A 604 that interacts with the respective hardware configurations 602 and 603. Therefore the OS-A layers 604 represent different environments. Therefore, while each OS-A 604 sees and shows different environments, each virtual machine layer 606 presents the same view to the user applications 610 as well as OS-B 608. Each software layering model also comprises a virtual machine layer 606 that interacts with a different OS-A environment 604 but presents identical embodiments to the OS-B layers 608.

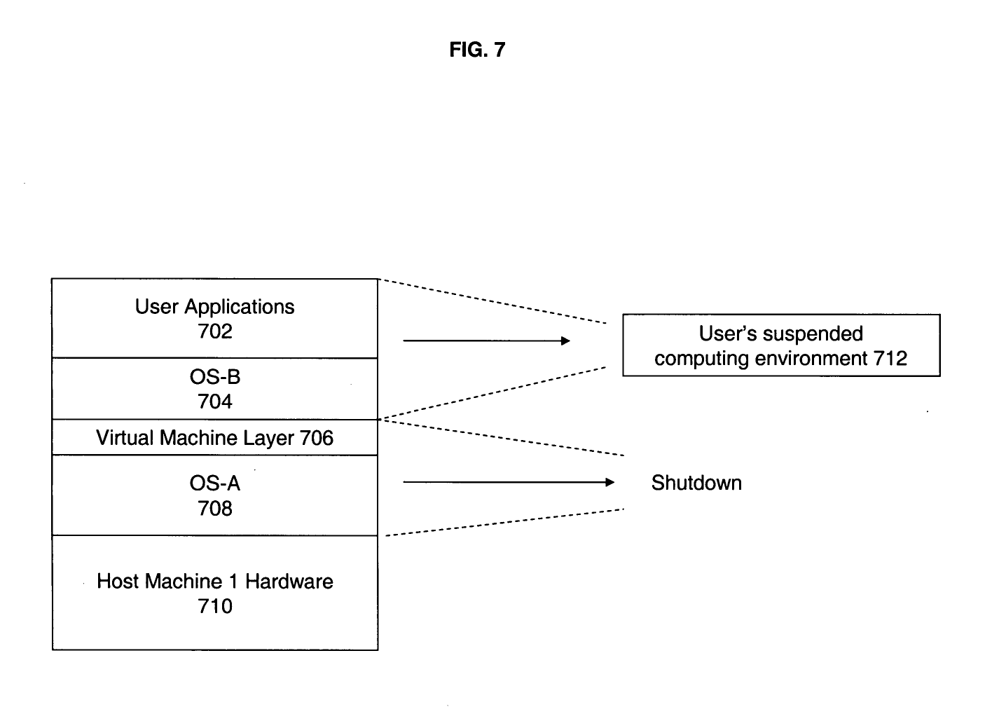

FIG. 7 shows a block diagram of a suspend operation. Once a user wishes to suspend a session on a host computer, he or she causes a suspend instruction to the virtual machine layer 706. In response the operation of user applications 702 and OS-B 704 are suspended by saving their current state in a storage area (e.g., file 712). The virtual machine layer 706 manages the user applications 702 and OS-B 704 during this process. Upon saving the current state, the virtual machine layer 706 and OS-A 708 are shut down because their state does not comprise any information of interest to the user for a subsequent session. The user's suspended computing environment is then saved in a portable server which is removed for coupling with another host in the subsequent session.

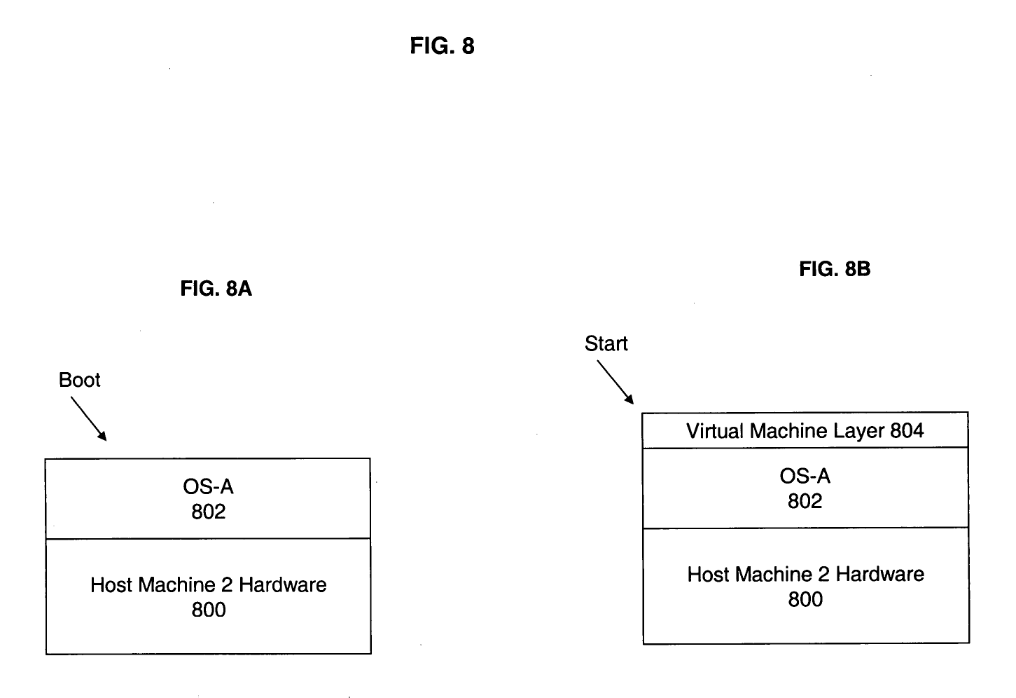

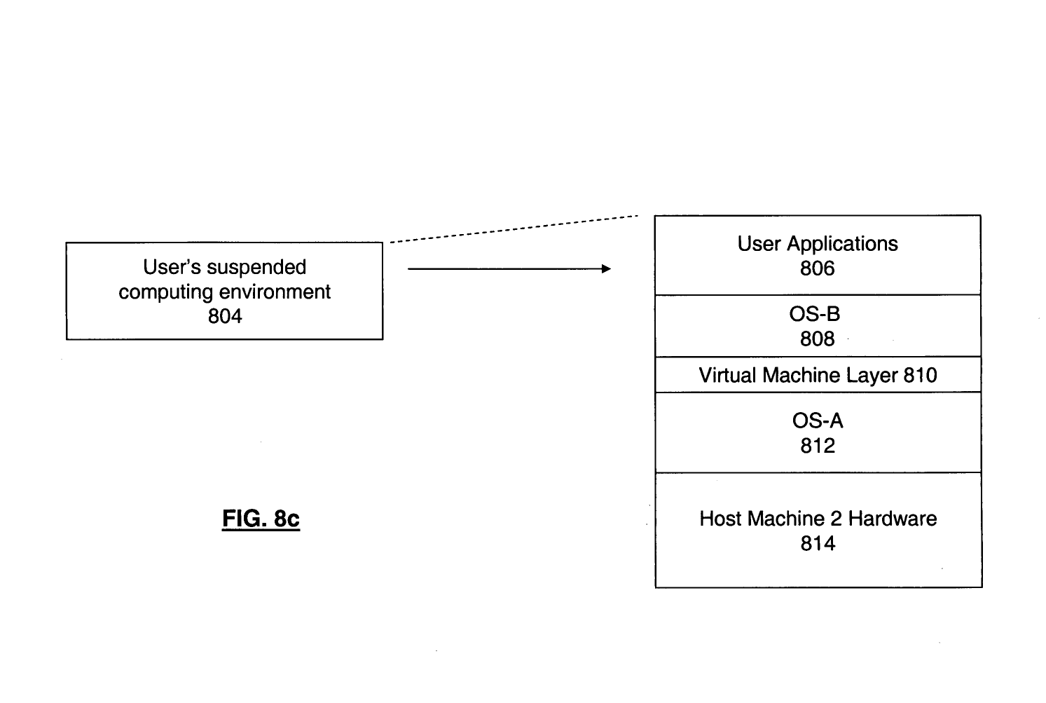

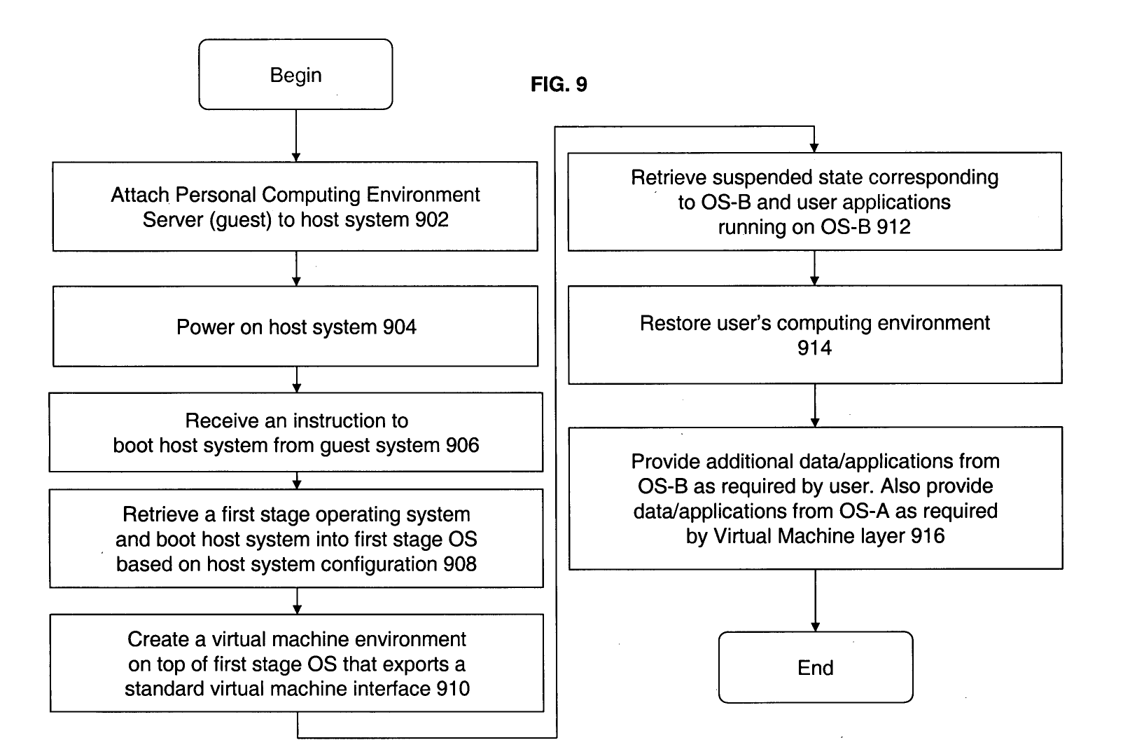

When the user wishes to resume work at another host, he or she connects the portable server to the second host and commences a resume operation. FIGS. 8A-C show such a resume operation. First, in FIG. 8A the OS-A 802 is booted by the second host machine hardware 800. Second, in FIG. 8B a virtual machine layer 804 is built on top of the OS-A 802. This virtual machine layer 804 acts as an interface between the host machine hardware 800 and the second level operating system OS-B 808 (shown in FIG. 8C). After the virtual machine layer is created, the host system then loads the second operating system OS-B 808 and the user applications from the portable server and then resumes the user's suspended computing environment 804.

Referring to FIG. 9, there is shown a flow chart illustrating a resume method 900 according to an embodiment of the invention. In step 902 the personal computing environment server (guest) system is attached to the host system. In step 904 the host system 302 (or 402) is powered on. In step 906 the host system receives an instruction to boot the host system from the guest system attached thereto. This instruction can take the form of a manual operation performed by the user during the boot process or it can be read from a bootable diskette or CD or it can be read from the Basic Input/Output System (BIOS) (provided that the BIOS was written to support booting from this type of device). In effect by booting from the guest system, the host system will come under the control of the guest system and bypass its own mass storage device. If the guest system is similar to the embodiment shown in 100, the host system 302 is instructed to boot from USB. If the guest system is similar to the embodiment shown in 200, the host system 402 is instructed to boot from Ethernet. The guest system 200 responds to the network boot request (BOOTP request) and initiates the boot operation of OS-A 512 from storage 202. The CPU 208 is used to manage this process.

In step 908 the host system retrieves a first stage operating system (OS) and boots into the first stage OS based on the host system configuration. In step 910 a virtual machine environment is created on top of the first stage OS that exports a standard virtual machine interface to the host system. In step 912 the host system retrieves the suspended state corresponding to OS-B and user applications running on OS-B. In step 914 the host system restore the user's computing environment in the host system. Finally, in step 916 the host system provides additional data and applications from OS-B as required by user. The host system also provides data and applications from OS-A as required by the Virtual Machine layer. In embodiment 200, the CPU 208 is used to recognize such requests and service them. Other network packets that are directed to external network sites are simply forwarded to Ethernet interface 208.

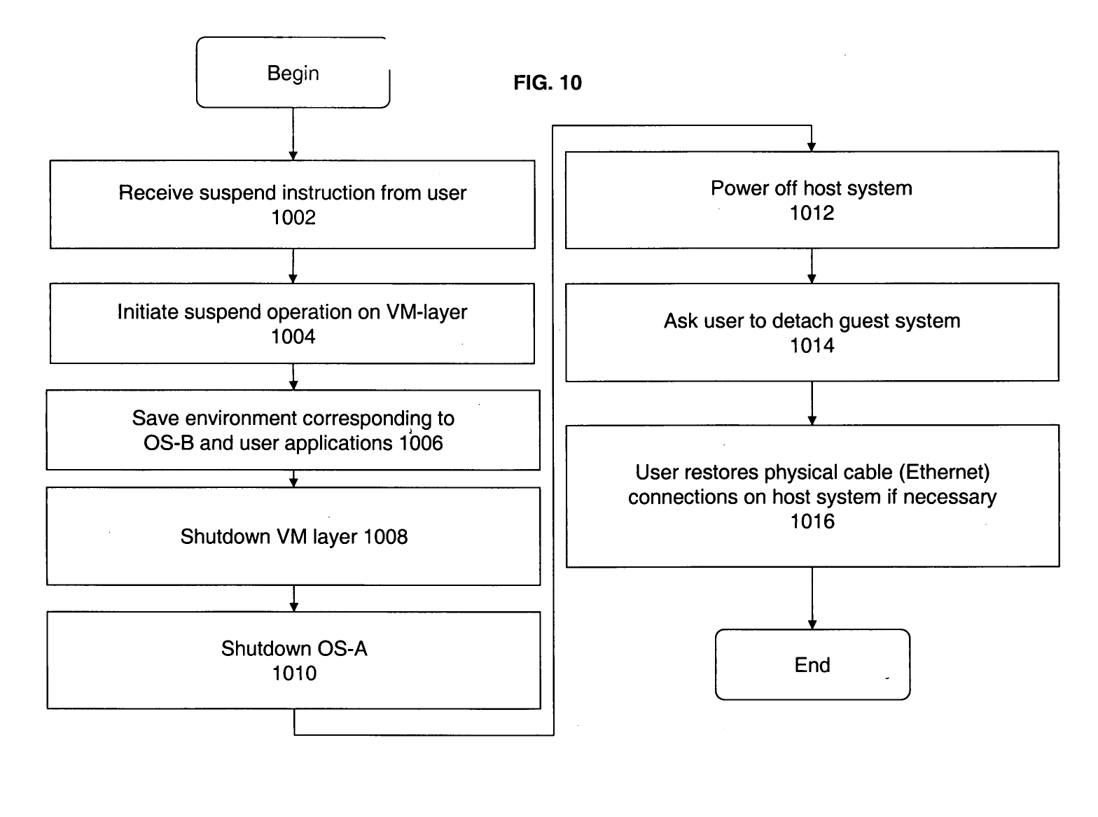

Referring to FIG. 10, there is shown a flow chart illustrating a suspend method 1000 according to an embodiment of the invention. In step 1002 the host system receives a suspend instruction from its user. In step 1004 the host system initiates a suspend operation on the virtual machine (VM) layer. Then in step 1006 the host saves the environment that corresponds to OS-B and the user applications. In step 1008 the VM layer is shut down. Then in step 1010 the OS-A is shut down. Step 1012 powers off the host system. In step 1014 the user is prompted to detach the guest system. After the guest system is detached the user can restore the physical connections to the host system, if necessary in step 1016.

As mentioned above, not all BIOS versions can boot from a USB device. For a system with such a BIOS, a user may create a diskette with a USB/Firewire driver. The first stage bootloader from the diskette and the rest of the boot process commences from the USB/Firewire disk.

Instead of using a wired Ethernet connection it is also possible to use a wireless local area network (LAN) connection according to IEEE standard 802.11.

A system as discussed above can change the entire computing paradigm. Consider the case of a hospital where electronic access to patient records is becoming more and more common. Each of the doctors can use a device according to the invention to carry his or her own portable personal computing environment server and connect it to different personal computers in the hospital (for example, in the radiology department, a central nursing station, etc.) and be able to securely access patient data. In another example, a knowledge worker could carry his portable personal computing environment server home, do some work at home and bring it back to work the next morning and connect to his office personal computer and resume where he left off without worry about synchronizing his data. The savings to the user could be significant. Over time, if some of the user's personal computers become diskless because they only operate in concert with his portable personal computing environment server, then all of the problems such as OS licenses, upgrades, security patches, backups, and the like go away.

Therefore, while there has been described what are presently considered to be the preferred embodiments, it will be understood by those skilled in the art that other modifications can be made within the spirit of the invention.

1. In a host information processing system, a method comprising:
connecting a portable personal computing environment server to the host system using an existing interface on the host system;
requesting the host system to boot from the portable personal computing environment server;
retrieving a first level operating system;
performing a first stage boot procedure using the first level operating system wherein the host system is booted based on its hardware configuration;
creating a machine-independent virtual configuration;
retrieving a suspended computing environment comprising a second level operating system from the portable personal computing environment server; and
performing a restore process with the suspended computing environment, wherein the restore process restores the suspended computing environment inside the virtual configuration.

2. The method of claim 1, further comprising retrieving one or more applications from the portable personal computing environment server.

3. The method of claim 1, further comprising retrieving one or more data files from the portable personal computing environment server.

4. The method of claim 1 wherein the first level operating system is a Linux operating system.

5. The method of claim 1 wherein the second level operating system is a Windows operating system.

6. The method of claim 1 wherein the instruction to load a first level operating system is received from the host basic input output system.

7. The method of claim 1 wherein the instruction to load a first level operating system is received from a bootable memory device.

8. The method of claim 1 wherein the instruction to load a first level guest operating system is received from a manual operation performed by a user.

9. The method of claim 1 wherein the first stage operating system is loaded from the portable personal computing environment server.

10. The method of claim 1 wherein at least a portion the first stage operating system is loaded from a removable storage device.

11. The method of claim 1 further comprising receiving a request to suspend the computing state and responsive to that request, storing the most current computing state in the portable personal computing environment server before shutting down the host system.

12. A portable personal computing environment server comprising:
a network subsystem for connecting to a host computer comprising a configuration; and
a mass storage device, coupled to the network subsystem, the mass storage device comprising a personal computing environment comprising one or more guest operating systems for restoring the personal computing environment.

13. The portable personal computing environment server of claim 12 wherein the mass storage device comprises one or more applications programs selected by the user of the portable personal computing environment server.

14. The portable personal computing environment server of claim 12 wherein the one or more guest operating systems further comprise a first stage bootloader for booting the host computer based on the actual configuration of the host computer.

15. The portable personal computing environment server of claim 12 wherein the mass storage device comprises one or more data files selected by the user of the portable personal computing environment server.

16. The portable personal computing environment server of claim 12 wherein the mass storage device comprises a computation state reflecting the latest state of the personal computing environment and wherein the portable personal computing environment server restores the computation state for presentation by the host computer upon booting the host computer.

17. A machine readable medium comprising program instructions for causing a host system to boot from a portable personal computing environment server coupled to the host system via an existing interface wherein the portable personal computing environment server comprises a personal computing environment comprising one or more guest operating systems for booting the host computer based on the personal computing environment.

18. The machine readable medium of claim 17 comprising a bootable removable storage device.

19. The machine readable medium of claim 18 comprising a bootable diskette.

20. The machine readable medium of claim 18 comprising a bootable CD ROM.

21. The machine readable medium of claim 18 comprising a removable USB storage device.
